(19) United States
(12) Patent Application Publication
(10) Pub. No.: US 2009/0035227 A1
(43) Pub. Date: Feb. 5, 2009

(54) CONFECTIONERY PRODUCTS COMPRISING A TOOTH-FRIENDLY SWEETENER

(76) Inventors: Stephan HAUSMANNS, Wiesbaden (DE); Tillmann DORR, Hohen-Sulzen (DE); Jorg KOWALCZYK, Eisenberg-Steinborn (DE); Rainer KLISS, Reinheim (DE); Tilo POTH, Weinheim (DE); Badr NFISSI, Dusseldorf (DE); Andre SCHIRLITZ, Neuss (DE)

Correspondence Address: OSTROLENK FABER GERB & SOFFEN, 1180 AVENUE OF THE AMERICAS, NEW YORK, NY, 100368403, US

(21) Appl. No.: 11/831,620

(22) Filed: Jul. 31, 2007

(51) Int. Cl. A61Q 11/00; A23G 1/00; A23G 3/32; A23G 3/36; A23G 3/38; A23G 3/42; A23G 3/54; A23G 4/00; A23G 4/20

(52) U.S. Cl. 424/49; 426/291; 426/302; 426/303; 426/304; 426/305; 426/416; 426/5; 426/509; 426/512; 426/519; 426/531; 426/533; 426/548; 426/571; 426/572; 426/573; 426/580; 426/601; 426/61; 426/631; 426/648; 426/650; 426/654; 426/656; 426/660; 426/662; 426/72; 426/74; 426/89; 433/215

(57) ABSTRACT

Confectionery products comprising a tooth-friendly sweetener, bioactive glass particles and at least one product additive, as well as processes for obtaining the products and various applications thereof.

### TECHNICAL FIELD

The present invention relates to confectionery products comprising a tooth-friendly sweetener, bioactive glass particles and at least one product additive, as well as processes for obtaining the product and various applications of these products and processes.

### BACKGROUND OF THE INVENTION

Due to the ever increasing demand of customers for confectionery products, which not only appeal because of their taste but also because of functional benefits, more and more innovative confectioneries are being developed. Among these products, in particular, are those which provide some health effects to the consumer, such as sugar-free confectionery products, which are acariogenic and suitable for consumers suffering from diabetes. Sugar-free confectionery products of such a type are disclosed for instance in DE 195 32 395 C2 and DE 196 39 342 C2. Numerous other references describe comestibles, in particular chewing gums and candies, which are prepared with sugarless constituents, such as sugar alcohols, and due to the absence of sucrose, provide some health effects.

Coated products, in particular confectionery, such as coated chewing gums or coated soft caramels, have been known for a long while. They are generally composed of a core, which may be a filled or non-filled chewing gum portion, and a one or multi-layered coating surrounding the core.

For instance, EP 0 664 674 B1 discloses a dual composition multi-layered hard coated chewing gum comprising a gum centre and an outer coating comprising xylitol and hydrogenated isomaltulose, also called isomalt. EP 0 314 739 B1 discloses improved hard coated sugarless chewing gums comprising a sugarless chewing gum centre and a sugarless hard coating comprising isomalt, wherein the gum centre has a low water content. EP 1 139 777 B1 discloses processes for coating comestibles with a syrup and a powder, both of them preferably being isomalt. U.S. Pat. No. 4,238,510 and U.S. Pat. No. 4,317,838 disclose sugarless coatings containing sorbitol being applied to chewing gum pieces and other confectionery. US 2006/0051456 A1 discloses chewing gums including a liquid filled composition, which may also comprise a coating surrounding the filled chewing gum. Thus, due to the use of sugar replacement agents, such as polyols, for instance isomalt, the prior art already provides tooth-friendly coated products.

However, although these products do not harm the health, in particular the health of teeth, it would be advantageous to provide confectionery, which even promotes the health of the consumer.

Medical care products for the prevention or reduction of oral diseases are also well known. U.S. Pat. No. 6,190,643, U.S. Pat. No. 4,851,046 or WO 2005/063185 as well as U.S. Pat. No. 5,735,942 describe the use of particles made of glass in compositions for oral care. The compositions described therein; however, are specialised products providing ingredients adapted for the pharmaceutical use. Confectionery products on the other hand have to address other needs, both in way of its production and properties. They are mainly produced in aqueous systems, have to display specific advantageous sensorical, organoleptical, optical and storage features and must be able to be prepared on a large scale in a cost effective way.

### SUMMARY OF THE INVENTION

Thus, the present invention is based on the technical problem to provide confectionery products, which do not only provide a pleasant and attractive appearance and taste, but which in addition promote the health of the consumer, in particular the consumers' oral health, most preferably the consumers' teeth.

The present invention solves this problem by the provision of the confectionery product, which comprises solely tooth-friendly ingredients, in particular tooth-friendly sweeteners and preferably tooth-friendly additives and in addition bioactive glass particles.

Thus, the present invention solves the above identified technical problem by providing a confectionery product, in particular a tooth-friendly confectionery product comprising a tooth-friendly sweetener and bioactive glass particles, optionally together with at least one product additive, which in a preferred embodiment is also tooth-friendly.

### DETAILED DESCRIPTION

In the context of the present invention, the term “tooth-friendly” refers to a feature of a product or a sweetener according to which the sweetener or product is a non-tooth-decay promoting sweetener, i.e. in particular does not cause caries in the oral cavity of a human being. Particularly, a tooth-friendly sweetener or product is not or only in an insignificant amount degraded in the oral cavity, thus avoiding acid formation therein. In particular, a tooth-friendly sweetener or product is not available as substrate for the enzyme glycosyl transferase that cavity forming bacteria generate for the synthesis of insoluble glucan. Said feature can be identified and measured by an in vitro insoluble glucan synthesis activity inhibition assay, in which in the absence or presence of the substance to be tested a glycosyl transferase reaction is carried out in the presence of sucrose. Furthermore, tooth-friendly substances or products can be recognised by another in vitro assay, according to which cavity forming bacteria are tested for its production of acids from substrates to be tested. Tooth-friendly substances are not fermented by these bacteria, so that the tooth-friendly substance, according to the present invention, is recognised in such an assay as being not degraded to acids. Finally, tooth-friendly substances can be identified by in vivo assays for non-cariogenity, for instance in animals such as rats.

It has been surprisingly shown that tooth-friendly sweeteners can successfully be used and prepared together with bioactive glass particles in order to provide organoleptical, sensorical and optically superior confectionery products, which not only prevent health problems in the oral cavity, in particular caries, but in addition promotes the health by reducing or avoiding gingivitis and plaque formation. The present confectionery products therefore provide a prophylactic and therapeutic effect to the health of the teeth when consuming confectionery products.

In a preferred embodiment of the present invention, the confectionery product comprises 15 to 99.85 weight-% of a tooth-friendly sweetener, 0.15 to 10 weight-% of bioactive glass particles having a particle size ≦25 μm and 0 to 75 weight-% of at least one product additive (each based on dry matter of confectionery product).

In a particularly preferred embodiment, the confectionery product comprises 20 to 99 weight-% of the tooth-friendly sweetener, 0.5 to 10 weight-% of bioactive glass particles having a particle size ≦25 μm and 0.5 to 70 weight-% of at least one product additive (each based on dry matter of confectionery product).

In a preferred embodiment of the present invention the product comprises 0.5 to 3 weight-% of the bioactive glass particles.

In a further preferred embodiment the product comprises 0.1 to 75 weight-%, preferably 20 to 55 weight-%, of the at least one product additive.

In a preferred embodiment of the present invention, the tooth-friendly sweetener is a sugar alcohol, preferably a mono- or disaccharide alcohol.

In a preferred embodiment of the present invention, the tooth-friendly sweetener is selected from the group consisting of 1,1-GPS (1-O-α-D-glucopyranosyl-D-sorbitol), 1,1-GPM (1-O-α-D-glucopyranosyl-D-mannitol), 1,6-GPS (6-O-α-D-glucopyranosyl-D-sorbitol, isomalt, isomalt GS, xylitol, sorbitol, maltitol, maltitol syrup, lactitol, mannitol and erythritol.

In the context of the present invention isomalt GS is a mixture of 1,6-GPS and 1,1-GPM in a ratio from 71 to 79% 1,6-GPS and 21 to 29% 1,1-GPM, preferably 75% 1,6-GPS to 25% 1,1-GPM. Isomalt is a mixture of 43 to 57% 1,6-GPS and 43 to 57% 1,1-GPM, preferably a 1:1 mixture (values given in weight-% on dry matter).

In a further preferred embodiment of the present invention, the sugar alcohol used is a milled and agglomerated isomalt, in particular a milled and agglomerated isomalt, wherein the milled isomalt particles have a diameter less that 100 μm, preferably less than 50 μm. Preferably, such a milled and agglomerated isomalt is isomalt DC.

In a preferred embodiment of the present invention, the confectionery product comprises the at least one sugar-alcohol, in particular isomalt or isomalt GS or isomaltulose, in form of particles, wherein 90% of said particles have a diameter of less than 100 μm, preferably less than 50 μm.

Particle size as described herein is measured by scanning electron microscopy (SEM) or other optical or screening techniques, for example using a Coulter counter.

In a preferred embodiment of the present invention, the tooth-friendly sweetener is a sugar.

In a preferred embodiment of the present invention, the tooth-friendly sugar is selected from the group consisting of isomaltulose, nutriose, leucrose and polydextrose. In a preferred embodiment, the sugar is isomaltulose.

In a further preferred embodiment, the amount of non-tooth-friendly ingredients is at maximum 1 weight-% (on dry matter of overall product).

In a preferred embodiment of the present invention, the confectionery product is sugar-free.

In a preferred embodiment of the present invention, the confectionery product is tooth-friendly.

In a further preferred embodiment, it is evident that depending upon the specific nature of the confectionery product, product additives may be present in the confectionery product or its coating.

Depending upon the nature of the confectionery product, it comprises 0 to 75 weight-%, preferably 0.1 to 60 weight-%, preferably 10 to 55 weight-%, most preferably 1 to 40 weight-% of such product additives.

In the context of the present invention, a product additive is any substance which may be added into the preparation process to either influence the preparation process itself and/or influence product characteristics, which may either be relevant for the process or for the finally obtained product, for instance its organoleptic, sensoric, physiological, storage or optical behaviour.

In a preferred embodiment of the present invention, the product additive is selected from the group consisting of intense sweeteners, hydrocolloid, gum base, plastifiers, lubricant, emulsifiers, protein components, milk components, dairy ingredients, fat and fat substitutes, vegetable fat, vitamins, minerals, pharmaceutically active ingredients, preservatives, aroma, flavourings, such as peppermint, menthol, fruit, strawberry flavour, colours, TiO₂, edible acids, such as citric acid, and dietary fibres.

In a preferred embodiment of the present invention, the intense sweetener is selected from the group of cyclamate, saccharin, aspartame, glycyrrhicine, neohesperidine-dihydrochalcone, steveoside, thaumatin, monellin, acesulfame, alitame, sucralose or a mixture thereof.

Particularly preferred is that the confectionery product or, if the product is a coated product, in particular the coating thereof, comprises casein, a component of casein, a phosphoprotein, a phosphopeptide or a salt thereof, wherein said phosphoprotein or phosphopeptide comprises phosphoserine, phosphothreonine, phosphotyrosine, phosphohistidine or phospholysine. Preferably, the confectionery products or coatings thereof comprise casein phosphopeptides (CPP), in particular phosphoserin, preferably together with di- or trivalent metals such as CaCPP, FeCPP, ZnCPP, calcium phosphate CPP or calcium fluoride CPP.

In a particularly preferred embodiment the confectionery product of the present invention, in particular a chewing gum, hard or soft caramel, or if the product is coated, preferably the coating thereof comprises casein phosphopeptid-amorphous calcium phosphate (CPP-ACP) as a further substance to remineralise enamel subsurface lesions in teeth.

In a further preferred embodiment, the present confectionery products or if coated, preferably the coating thereof, in particular chewing gums or hard caramels, comprise CPP-ACP and citric acid in addition to the agglomerates of the present invention.

In a further preferred embodiment, the present invention relates to confectionery products, or in the case that the confectionery products are coated, preferably the coating thereof, which comprises a two-phase-system comprising as one phase at least one water-soluble calcium-compound and as another phase comprising at least one water-soluble inorganic phosphate and, optionally, at least one water-soluble fluorine compound, wherein, in a further preferred embodiment the water-soluble calcium salt may be calcium chloride or calcium nitrate.

In a further preferred embodiment, the present invention relates to confectionery products, or in the case that the confectionery products are coated, preferably the coating thereof, comprising the agglomerates of the present invention and a complex comprising arginine together with calcium, carbonate and bicarbonate (CaviStat®/SensiStat®).

In a further preferred embodiment of the present invention, there is provided a confectionery product or, in case the confectionery product is a coated product, preferably the coating thereof, which comprises a nerve-desensitising agent selected from the group consisting of a potassium salt, a strontium salt, a combination of zinc or strontium ions and mixtures thereof. Preferably, said salts may be associated with a controlled dissolution composition, comprising at least one water-swellable or water soluble polymer.

In a further preferred embodiment of the present invention, there are provided confectionery products, or in the case that the confectionery products are coated product, preferably coatings thereof, which comprise a modified enzyme comprising an enzyme and at least one polyanionic domain, for instance polyglutamic acid, polyaspartic acid or a polycarboxylic acid, wherein the enzyme comprises or is covalently attached to each of said polyanionic domain.

In a further preferred embodiment of the present invention, there is provided a confectionery product, or in case the confectionery product is a coated product, preferably a coating thereof, which comprises a water-soluble calcium-phosphate salt, or a monolithic combination of calcium and phosphate salts in a first carrier and additionally an alkaline material and a fluoride ion source in a second carrier.

In a further preferred embodiment, the present invention provides confectionery products of the present invention, or if coated, preferably the coating thereof, in particular chewing gums, or soft or hard caramels, which comprise tetracalcium phosphate/dicalcium phosphate.

In a preferred embodiment of the present invention, the product additive is selected from the group consisting of a) casein phosphopeptide-amorphous calcium phosphate (CPP-ACP), b) tetracalciumphosphate/dicalciumphosphate, c) a two-phase system comprising a water soluble calcium compound and a water soluble inorganic phosphate in combination with at least one soluble fluorine compound, d) potassium salt, e) strontium salt, f) a combination of strontium and zinc ions, g) a modified enzyme comprising an enzyme and a polyanionic domain, h) a complex comprising arginine, calcium, carbonate and bicarbonate and i) a combination thereof.

In the context of the present invention, the term “bioactive glass” refers to an inorganic glass material having silicon oxide as its major component and which is capable of bonding with living tissue when reacted with physiological fluids, such as saliva. In particular, a bioactive glass in accordance with the present invention is a glass composition that will form a layer of hydroxycarbonate apatite in vitro when placed in a simulated body fluid. Preferably, a bioactive glass is biocompatible, i.e. does not trigger an overwhelmingly adverse immune response in the body, such as the oral cavity.

Bioactive glasses are described for example in “An Introduction to Bioceramics”, Hench and Wilson, eds. World Scientific, New Jersey (1993).

In a preferred embodiment of the present invention, the confectionery products include bioactive glass particles with a composition as follows: from 40 to 90% by weight of silicon dioxide (SiO₂), from 4 to 50% by weight calcium oxide (CaO), from 1 to 15% by weight phosphorous oxide (P₂O₅) and from 0 to 35% by weight of sodium oxide (Na₂O). Preferably, the bioactive glass includes from 40 to 60% by weight of silicon dioxide (SiO₂), from 10 to 30% by weight calcium oxide (CaO), from 2 to 8% by weight phosphorous oxide (P₂O₅) and from 10 to 30% by weight sodium oxide (Na₂O). The oxides can be present as solid solutions or mixed oxides, or as a mixture of oxides.

In a further preferred embodiment, Al₂O₃, B₂O₃, CaF₂, MgO or K₂O may in addition be included in the glass particles. The preferred range for CaF₂ is from 0 to 25% by weight. The preferred range for B₂O₃ is from 0 to 10% by weight. The preferred range for Al₂O₃ is from about 0 to 5% by weight. The preferred range for K₂O is from 0 to 10% by weight. The preferred range for MgO is from 0 to 5% by weight.

The most preferred glass is a glass, which has a composition of 45% by weight silicon dioxide, 24.5% by weight sodium oxide, 6% by weight phosphorous oxide and 24.5% by weight calcium oxide.

The glass composition for use in the present invention can be prepared in various ways, so as to provide melt-derived glass, sol-gel derived glass or sintered glass particles. The sintered particles can be in sol-gel derived or in pre-reacted melt derived form. A sol-gel derived glass is conventionally prepared by synthesising an inorganic frame by mixing metal alkoxides in solution, followed by hydrolysis, gelation, and low temperature, for example 190 to 910° C. and firing to produce a glass. A melt-derived glass is conventionally prepared by mixing grains of oxides or carbonates, melting and homogenising the mixtures at high temperatures, typically from 1200 to 1500° C. The molten glass can be fritted and milled to produce small particles.

The present invention preferably uses melt-derived bioactive glass particles.

In a preferred embodiment of the present invention, the bioactive glass particles comprise from 40 to 86 weight-% SiO₂ (silicon dioxide), 4 to 46 weight-% CaO (calcium oxide), 1 to 15% P₂O₅ (phosphorus oxide) and 0 to 35 Na₂O (sodium oxide).

In a preferred embodiment of the present invention, the bioactive glass particles have a particle size ≦15 μm, preferably ≦10 μm.

In a preferred embodiment of the present invention, the product is selected from the group of chewing gums, hard caramels, soft caramels, toffee, pastille, tablets, gum, jellies, marshmallows, nougat, lozenges, fudge, fondant or chocolate products.

In the context of the present invention, a tablet is a compressed product, i.e. a product prepared by mixing its ingredients in dry and powdered from and exerting pressure on said mixture to obtain a solid so-called compressed product.

In the context of the present invention, a hard candy and a soft candy is also called a hard caramel and a soft caramel.

In a preferred embodiment of the present invention, the confectionery product is a coated product.

In a preferred embodiment of the present invention, the coated product is a coated chewing gum, a coated toffee, a coated jelly, a coated tablet, a coated soft caramel or a coated chocolate product.

In a preferred embodiment of the present invention, the coated product comprises 15 to 70, preferably 25 to 45, weight-% product coating (based on dry weight of the overall coated product). Preferably, the coated product comprises 30 to 85, preferably 55 to 75 weight-% product core (based on the dry weight of the overall coated product).

In a particularly preferred embodiment, the product coating may comprise 1, 2 or more, for instance 50 to 100 layers of product coating material. In a particularly preferred embodiment, said layers may be of the same or different compositions.

In a preferred embodiment of the present invention, the bio-active glass particles are contained in the coating of the coated product, preferably are solely contained therein.

A preferred embodiment of the present invention relates to a process for the preparation of a hard caramel mass, which comprises 15 to 99.85 weight-% of at least one tooth friendly sweetener, 0.15 to 10 weight-% of bio-active glass particles and 0 to 75 weight-% of at least one product additive, wherein the process comprises a) dissolving the sweetener in an aqueous medium, b) boiling the obtained solution to evaporate the aqueous medium, c) cooling the obtained mass, d) adding and distributing the at least one product additive to obtain a hard caramel mass, wherein the bio-active glass particles are added and homogenously distributed in the boiled sweetener at the end of step b) or in step c) or d). In the context of the present invention the end of step b) is reached once substantially all of the aqueous medium has been evaporated so as to leave a highly viscous hard caramel mass. Preferably, the aqueous medium is water.

In a preferred embodiment of the present invention, the boiling in step b) is done under vacuum.

A preferred embodiment of the present invention relates to a process for the preparation of a hard caramel mass, which comprises 15 to 99.85 weight-% of at least one tooth friendly sweetener, 0.15 to 10 weight-% of bio-active glass particles and 0 to 75 weight-% of at least one product additive, wherein the process comprises a′) melting the sweetener, b′) cooling the obtained mass, c′) adding and distributing the at least one product additive to obtain a hard caramel mass wherein the bioactive glass particles are added and homogenously distributed in the sweetener in step a′) or in step b′) or c′).

In a preferred embodiment of the present invention, the hard caramel mass as obtained according to the above boiling or melting process is shaped into a hard caramel.

A preferred embodiment of the present invention relates to a process for the preparation of coated confectionery products, which comprises a product core and a product coating, the coating comprising at least the coating ingredients at least the tooth-friendly sweetener, the bioactive particles and the at least one product additive, preferably according to the above, which process comprises a) applying a coating medium comprising at least partially the coating ingredients to said product core, and b) drying the coated product, so as to obtain a product coating, which comprises 0.15 to 10 weight-% tooth-friendly sweetener, 0.15 to 10 weight-% of the bioactive glass particles and 0 to 75 weight-% (each based on dry weight of product coating) of at least one product additive. If, in one preferred embodiment, only a part of the coating ingredients is added into the coating medium, then the other part is applied in a dusting or drying step thereafter.

In the context of the present invention, drying of the coated core with a dry and powdered ingredient is also called dusting.

Preferably, the coating medium is an aqueous medium, particularly water.

In a preferred embodiment of the present invention, the coating medium is a coating solution or coating suspension.

In a preferred embodiment of the present invention, after step a) and before step b) the coated products are subjected to a distribution step, wherein the coated products are agitated to allow a homogenous distribution of the coating medium on the product core.

In a preferred embodiment of the present invention, the drying of step b) is done by subjecting the coated product to air, in particular an air stream, having a temperature of 20° C. to 80° C., preferably 30° C. to 80° C.

In a preferred embodiment of the present invention, in step a) all coating ingredients are applied in form of a coating medium, in particular a coating suspension.

In a preferred embodiment of the present invention, steps a) and b) are repeated one or more times, preferably 8 to 120 times.

In a preferred embodiment of the present invention, the drying of step b) is done by adding part, preferably the overall amount of the bioactive glass particles of the coating ingredients in dry and powdered form to the coated products during step b). In this embodiment it is preferred to further add at least a part of the at least one sweetener in dry and powdered form to the coated product in step b), that means to use a mixture of the glass particles and the tooth-friendly sweetener for dusting.

In a preferred embodiment of the present invention, a part of the coating ingredients, preferably the at least one sweetener and the at least one additive is applied in form of a coating medium in step a) and a further part, preferably the overall amount of the bioactive glass particles, is applied in dry and powdered form, in step b).

In a most preferred embodiment of the present invention, all of the bioactive glass particles of the product coating is added in dry and powdered form, preferably together with a part of the at least one tooth-friendly sweetener, preferably in step b).

In a preferred embodiment of the present invention, at least a part of the at least one tooth-friendly sweetener is added in dry and powdered form.

In a preferred embodiment of the present invention, the coating ingredients applied in powder form represent 30 to 75% by weight, preferably 40 to 75% by weight of the overall amount of the coating ingredients (each based on dry weight of the product coating).

In a preferred embodiment of the present invention, steps a) and b) are repeated 3 to 10 times.

In a preferred embodiment of the present invention, the method of the present invention is carried out in at least two phases, wherein in a first phase of the method, the coating medium with a part of the coating ingredient is applied in step a) and the drying is done in step b) by adding part of the coating ingredients in dry and powdered form, preferably all of the bioactive glass particles, to the coated products one or more repeated times and wherein in a second phase of the method the coating medium is applied to the coated products without addition of dry and powdered coating ingredients one or more repeated times.

In a preferred embodiment of the present invention, the drying of step b) is done both by subjecting the coated product to air having a temperature of 20 to 80° C. and by adding part of the coating ingredients in dry and powdered form to the coated products during step b).

In a preferred embodiment of the present invention, in a first phase of the repetitions of steps a) and b) the drying of step b) is done by adding part of the coating ingredients in dry and powdered form, preferably all of the bioactive glass particles, to the coated products and wherein in a second phase of the repetitions only the coating medium is applied and the drying of step b) is done by subjecting the coated product to air having a temperature of 20 to 80° C.

In a preferred embodiment of the present invention, steps a) and b) are repeated 3 to 50 times.

The present invention also relates to a process for the preparation of compressed products comprising 15 to 99.85 weight-% of the tooth-friendly sweetener, 0.15 to 10 weight-% of the bioactive glass particles having a particle size ≦25 μm and 0 to 75 weight-% of at least one product additive, wherein said product ingredients are mixed and set under pressure, in particular in a suitable form, so as to obtain a compressed product, that means a tablet.

The present invention also relates to the use of bioactive glass particles for the preparation of a confectionery product for preventing or reducing oral and dental defects, in particular by a calcium-transfer mechanism mediated by the presently used glass particles. In a preferred embodiment of the present invention, said confectionery products are tooth-friendly confectionery products, in particular confectionery products comprising tooth-friendly sweeteners as defined herein.

The present invention relates to the use or method of using bioactive glass particles to prepare a confectionery product, in particular a sensorically and organoleptically improved confectionery product, preferably a sugar-free confectionery product, comprising 0.15 to 10% bioactive glass particles having a particle size ≦25 μm and 0 to 75 weight-% of at least one product additive and 15 to 99.85 weight-% of a tooth-friendly sweetener for preventing or treating caries.

The present invention relates to the use or method of using bioactive glass particles to prepare a confectionery product, in particular a sensorically and organoleptically improved confectionery product, preferably a sugar-free confectionery product, comprising 0.15 to 10% bioactive glass particles having a particle size ≦25 μm and 0 to 75 weight-% of at least one product additive and 15 to 99.85 weight-% of a tooth-friendly sweetener for preventing or treating pain-sensitive teeth.

The present invention relates to the use or method of using bioactive glass particles to prepare a confectionery product, in particular a sensorically and organoleptically improved confectionery product, preferably a sugar-free confectionery product, comprising 0.15 to 10% bioactive glass particles having a particle size ≦25 μm and 0 to 75 weight-% of at least one product additive and 15 to 99.85 weight-% of a tooth-friendly sweetener for remineralisation of tooth-defects.

Further preferred embodiments of the present invention are the subject-matter of the subclaims.

### EXAMPLES

The invention is illustrated by way of the following examples. These examples are provided only for the purpose of illustrating the invention and are not to be construed as limiting the invention in any manner.

### Example 1

### Preparation of a Coated Chewing Gum

### A) Composition of the Coated Chewing Gum:

TABLE 1
Center:

| | Amount [% based on weight |
|---|---|
| Ingredient | of center] |
| Glycerol | 1.78 |
| Water | 1.30 |
| Xylitol | 7.81 |
| Mannitol | 7.92 |
| Maltitol | 0.63 |
| Sorbitol | 44.40 |
| 1,1-Glucopyranosyl-mannitol (1,1- | 0.02 |
| GPM) | |
| 1,6-Glucopyranosyl-sorbitol (1,6-GPS) | 0.06 |
| Gum base | 36.08 |

TABLE 2
Coating:

| | Amount [% based on dry |
|---|---|
| Ingredient | weight of coating] |
| Isomalt GS (75 weight-% 1,6-GPS, 25 | 93.00 |
| weight-% 1,1-GPM) | |
| Gum arabic | 1.40 |
| Bioactive glass particles (particle size | 5.60 |
| ≦15 μm) | |

B) Coating with Dry Charged Bioactive Glass Particles

A coating solution comprising as coating ingredients 5500 g isomalt GS, 410 g of a 50% gum arabic solution (205 g gum arabic, dry matter) and 3980 g water was prepared. Chewing gum cushions with a weight of 1,018 g/pc are provided. In a coating drum, the coating solution is applied to the chewing gum cushions at 60° C., wherein during said coating a mixture of isomalt GS/PA (powder, 90% of the particles <50 μm) and 0.1% SiO₂ is sequentially added as powdery dry charges in a first phase, in a second phase of 7×150 g and in a third phase of 4×170 g. The applied coating layers are dried after each cycle with a constant air stream with a temperature ranging from 23 to 28° C. Afterwards, the surface is dusted with the glass particles in a fourth phase in 5 cycles, in a fifth phase in 5 cycles and in a sixth phase in 3 cycles. The applied coating layers are dried after each cycle with a constant air stream. Thus, in overall, a coated product is prepared comprising 33 weight-% coating and about 67 weight-% (each based on dry weight of final product) chewing gum centre.

The obtained coated chewing gums have excellent organoleptical, sensorical and also optical properties and are tooth-friendly.

### Example 2

### Chewing Gum

### Recipe:

| | |
|---|---|
| chewing base Nostic TWA | 1.5 kg |
| isomalt ST | 2.4 kg |
| sorbitol syrup (70% dry substance) | 0.6 kg |
| bioactive glass particles (≦15 μm) | 0.1 kg |
| glycerol | 0.15 kg |
| menthol | 0.15 kg |
| flavour (spearmint) | 0.1 kg |
| aspartam | 2.5 kg |
| acesulfam K | 2.5 kg |

### Preparation:

The chewing gum base is heated at approximately 55° C. in a heating oven, before it is placed in a kneader; subsequently, the chewing gum base is kneaded for 1-2 minutes. During the kneading, the powdery additives (isomalt ST (1:1 mixture of 1,6-GPS and 1,1-GPM), the bioactive glass particles, sweetener, menthol) are gradually added in the indicated sequence; afterwards, flavour, sorbitol syrup and glycerol are added. The kneading continues until the mass is homogenous (end temperature approximately 45° C.). The mass is taken from the kneader and divided into portions which weigh approximately 1 kg.

The chewing gum mass divided into portions is placed in intermediate storage for approximately 15 to 20 min on a talc-strewn substrate, extruded with a suitable extruder, and further processed as usual.

The obtained non-coated chewing gums have an acceptable texture and good organoleptical and sensorical behaviour. Furthermore, they are tooth-health promoting.

### Example 3

### Preparation of a Hard Caramel

### Recipe:

| | | |
|---|---|---|
| isomalt ST | 24.5 | kg |
| bioactive glass particles (≦15 μm) | 0.5 | kg |
| water | 8 | kg |
| menthol | 0.1 | kg |
| peppermint | 0.4 | kg |
| acesulfam K | 25 | g |

### Preparation:

Isomalt ST and water are mixed in a pan followed by heating to dissolve the isomalt and boiling this mixture at a temperature from 155 to 160° C. A 5 minute vacuum was applied so as to obtain a highly viscous caramel mass and after cooling of the mass to 110° C. to 115° C. the citric acid, the aroma, acesulfam K and the bioactive glass particles are added and are homogenously distributed. The so prepared hard caramel mass was moulded to form hard candies.

The above-identified recipe without water has also been processed directly to a hard caramel in a melt extrusion process by simultaneously extruding the ingredients and forming hard caramels therefrom.

In a continuously operating process, the bioactive glass particles have been added after boiling of the isomalt ST-solution into the highly viscous, but still liquid hard caramel mass, which thereafter is transferred with the homogenously distributed bioactive glass on a cooling belt and further processed by moulding and cooling in order to obtain the final hard caramels.

The obtained hard caramels proved to be satisfactory in its organoleptical, optical and sensorical properties, while they simultaneously provide superior health effects to the teeth of the consumer.

### Example 4

### Tablets

### Recipe:

| | | |
|---|---|---|
| isomalt DC 100 | 9.9 | kg |
| bioglass particles | 0.3 | kg |
| acesulfam K | 15 | g |
| citric acid | 30 | g |
| aroma (strawberry) | 50 | g |
| magnesium stearat | 50 | g |

### Preparation:

The components were mixed and compressed in a rotary press.

| | |
|---|---|
| Tablet diameter: | 12 mm |
| Tablet weight | app. 600 mg |
| pressure force | 8-15 kN |
| hardness | 140-220 N |

The obtained tablets proved to be satisfactory in its organoleptical, optical and sensorical properties, while they simultaneously provide superior health effects to the teeth of the consumer.

What is claimed is:

1. A confectionery product comprising 15 to 99.85 weight-% of a tooth-friendly sweetener, 0.15 to 10 weight-% of bioactive glass particles having a particle size ≦25 μm and 0 to 75 weight-% of at least one product additive, wherein each weight-% value is based on an amount of dry matter in the confectionery product.

2. The confectionery product of claim 1, wherein the tooth-friendly sweetener is a sugar alcohol.

3. The confectionery product of claim 1, wherein the tooth-friendly sweetener is a sugar.

4. The confectionery product according to claim 1, wherein the tooth-friendly sweetener is selected from the group consisting of 1,1-GPS (1-O-α-D-glucopyranosyl-D-sorbitol), 1,1-GPM (1-O-α-D-glucopyranosyl-D-mannitol), 1,6-GPS (6-O-α-D-glucopyranosyl-D-sorbitol, isomalt, isomalt GS, xylitol, sorbitol, maltitol, maltitol syrup, lactitol, mannitol and erythritol.

5. The confectionery product according to claim 1, wherein the tooth-friendly sweetener is selected from the group consisting of isomaltulose, nutriose, leucrose and polydextrose.

6. The confectionery product according to claim 1, wherein the confectionery product is sugar-free.

7. The confectionery product according to claim 1, wherein the confectionery product is tooth-friendly.

8. The confectionery product according to claim 1, wherein the confectionery product is selected from the group consisting of chewing gums, hard caramels, soft caramels, toffee, pastille, tablets, gum, jellies, marshmallows, nougat, lozenges, fudge, fondant and chocolate products.

9. The confectionery product according to claim 1, wherein the confectionery product is a coated product.

10. The confectionery product according to claim 1, wherein the confectionery product is a coated product and wherein the coated product is a coated chewing gum, a coated jelly, a coated tablet, a coated soft-caramel or a coated chocolate product.

11. The confectionery product according to claim 1, wherein the at least one product additive is selected from the group consisting of intense sweeteners, hydrocolloid, gum base, plastifiers, emulsifiers, protein components, milk components, dairy ingredients, fat and fat substitutes, vegetable fat, vitamins, minerals, pharmaceutically active ingredients, preservatives, aroma, flavourings, colours, TiO₂, edible acids and dietary fibres.

12. The confectionery product according to claim 1, wherein the at least one product additive is an intense sweetener and wherein the intense sweetener is selected from the group consisting of cyclamate, saccharin, aspartame, glycyrrhicine, neohesperidine-dihydrochalcone, steveoside, thaumatin, monellin, acesulfame, alitame, sucralose and mixtures thereof.

13. The confectionery product according to claim 1, wherein the at least one product additive is selected from the group consisting of a) casein phosphopeptide-amorphous calcium phosphate (CPP-ACP), b) tetracalciumphosphate/dicalciumphosphate, c) a two-phase system comprising a water soluble calcium compound and a water soluble inorganic phosphate in combination with at least one soluble fluorine compound, d) potassium salt, e) strontium salt, f) a combination of strontium and zinc ions, g) a modified enzyme comprising an enzyme and a polyanionic domain and h) combinations thereof.

14. The confectionery product according to claim 1, wherein the bioactive glass particles comprise from 40 to 90 weight-% SiO₂ (silicon dioxide), 4 to 50 weight-% CaO (calcium oxide), 1 to 15% P₂O₅ (phosphorus oxide) and 0 to 35 Na₂O (sodium oxide).

15. The confectionery product according to claim 1, wherein the bioactive glass particles have a particle size ≦15 μm.

16. The confectionery product according to claim 9, wherein the bioactive glass particles are contained in the coating of the coated product.

17. A process for the preparation of a hard caramel mass comprising 15 to 99.85 weight-% of at least one tooth friendly sweetener, 0.15 to 10 weight-% of bio-active glass particles and 0 to 75 weight-% of at least one product additive, wherein the process comprises a) dissolving the sweetener in an aqueous medium to form a solution, b) boiling the obtained solution to evaporate the aqueous medium, c) cooling the obtained mass, d) adding and distributing the at least one product additive to the mass to obtain a hard caramel mass, wherein the bio-active glass particles are added and homogenously distributed in the boiled sweetener at the end of step b) or in step c) or d).

18. The process for the preparation of a hard caramel mass according to claim 17, wherein the boiling in step b) is done under vacuum.

19. A process for the preparation of a hard caramel mass comprising 15 to 99.85 weight-% of at least one tooth friendly sweetener, 0.15 to 10 weight-% of bio-active glass particles and 0 to 75 weight-% of at least one product additive, wherein the process comprises a′) melting the sweetener, b′) cooling the obtained hard caramel mass, c′) adding and distributing the at least one product additive to obtain a hard caramel mass, wherein the bioactive glass particles are added and homogenously distributed in step a′), b′) or c′).

20. A process for the preparation of a hard caramel mass according to claim 19, wherein the hard caramel mass is shaped to a hard caramel.

21. A process for the preparation of a coated confectionery product comprising a product core and a product coating, the product coating comprising a coating medium comprising the tooth-friendly sweetener, the bioactive particles and the at least one product additive according to claim 1, wherein the process comprises a) applying the coating medium to said product core to form a coated product, and b) drying the coated product, so as to obtain a product coating which comprises 0.15 to 10 weight-% tooth-friendly sweetener, 0.15 to 10 weight-% of the bioactive glass particles and 0 to 75 weight-%, of at least one product additive, wherein each weight-% value is based on the dry weight of product coating

22. The process of claim 21, wherein the drying of step b) is done by subjecting the coated product to air.

23. The process of claim 21, wherein the drying of step b) is done by adding at least a part of the coating ingredients in dry and powdered form to the coated products during step b).

24. The process of claims 21 wherein the coating medium is a coating solution or coating suspension.

25. The process according to claim 21, wherein after step a) and before step b) the coated products are subjected to a distribution step, wherein the coated products are agitated to allow a homogenous distribution of the coating medium on the product core.

26. The process according to claim 21, wherein in step a) all coating ingredients are applied in form of a coating medium.

27. The process according to claim 21, wherein a first portion of the coating ingredients is applied in the coating medium and a second portion is applied in dry and powdered form, both of said portions being applied in step a).

28. The process according to claim 21, wherein all of the bioactive glass particles in the product coating are added in dry and powdered form in step b).

29. The process according to claim 21, wherein all of the bioactive glass particles in the product coating are added in dry and powdered form and a portion of at least one tooth-friendly sweetener is added in dry and powdered form, both of them in step b).

30. The process according to claim 21, wherein at least a part of the tooth-friendly sweetener is added in dry and powdered form in step b).

31. The process of claim 21, wherein steps a) and b) are repeated.

32. The process according to claim 21, wherein steps a) and b) are repeated 3 to 10 times.

33. The process according to claim 21, wherein the coating ingredients applied in powder form represent 30 to 75% by weight of the overall amount of the coating ingredients, wherein the weight-% value is based on dry weight of the product coating.

34. The process according to claim 21, wherein the process is carried out in at least two phases, wherein in a first phase of the process, the coating medium comprising a portion of the coating ingredients is applied in step a) and the drying is done in step b) by adding a portion of the coating ingredients in dry and powdered form to the coated products one or more times and wherein in a second phase of the process the coating medium is applied to the coated products in step a) and dried in step b) by subjecting the coated product to air, without addition of dry and powdered coating ingredients, one or more times.

35. The process according to claim 21, wherein the drying of step b) is done both by subjecting the coated product to air having a temperature of 20 to 80° C. and by adding a portion of the coating ingredients in dry and powdered form to the coated products during step b).

36. The method according to claim 35, wherein steps a) and b) are repeated 3 to 50 times.

37. The method according to claim 36, wherein in a first phase of the repetitions of steps a) and b) the drying of step b) is done by adding a portion of the coating ingredients in dry and powdered form to the coated products and wherein in a second phase of the repetitions only the coating medium is applied and the drying of step b) is done by subjecting the coated product to air having a temperature of 20 to 80° C.

38. A method for preventing or treating caries in an animal or human being comprising applying a confectionery product which comprises 15 to 99.85 weight-% of at least one tooth-friendly sweetener, 0.15 to 10 weight-% of bioactive glass particles and 0 to 75 weight-% of at least one product additive to an animal or human being in need thereof.

39. A method for preventing or treating pain-sensitive teeth in an animal or human being comprising applying a confectionery product which comprises 15 to 99.85 weight-% of at least one tooth-friendly sweetener, 0.15 to 10 weight-% of bioactive glass particles and 0 to 75 weight-% of at least one product additive to an animal or human being in need thereof.

40. A method for the remineralisation of tooth-defects in an animal or human being comprising applying a confectionery product which comprises 15 to 99.85 weight-% of at least one tooth-friendly sweetener, 0.15 to 10 weight-% of bioactive glass particles and 0 to 75 weight-% of at least one product additive to an animal or human being in need thereof.

41. The confectionery product according to claim 15, wherein the bioactive glass particles have a particle size ≦10 μm.

42. The confectionery product according to claim 16, wherein the bioactive glass particles are solely contained in the coating.

43. The process of claim 21, wherein the drying of step b) is done by subjecting the coated product to an air stream having a temperature of 20° C. to 80° C.

44. The process of claim 26, wherein in step a) all coating ingredients are applied in a coating suspension.
